(19) United States
(12) Patent Application Publication
(10) Pub. No.: US 2007/0239578 A1
(43) Pub. Date: Oct. 11, 2007

(54) Method For Initializing An Exchange Of Services Between At Least Two Parties

(76) Inventor: Klemens Gaida, Duesseldorf (DE)

Correspondence Address: ST. ONGE STEWARD JOHNSTON & REENS, LLC, 986 BEDFORD STREET, STAMFORD, CT, 06905-5619, US

(21) Appl. No.: 11/763,907

(22) Filed: Jun. 15, 2007

Related U.S. Application Data
(63) Continuation of application No. PCT/EP05/12656, filed on Nov. 26, 2005.

(30) Foreign Application Priority Data
Dec. 16, 2004 (DE) 10 2004 061 171.8

(51) Int. Cl. G06Q 40/00

(52) U.S. Cl. 705/35

(57) ABSTRACT

A method for initializing an exchange of services between at least two parties, including transactions in relation to the acquisition of products or the utilization of services. Optical or acoustic information on at least one of the products or services of interest to the user of a mobile terminal are acquired by means of a mobile terminal that is operated in a telecommunication network. The acquired information is transmitted to a data processing system linked with the telecommunication network via a message service of the telecommunication network. The processing system determines additional information on the product or service of interest to the user of a mobile terminal using the acquired information. The additional information so determined is at least partially transmitted to the mobile terminal of the user via a message service of the telecommunication network and is displayed by the mobile terminal.

### CROSS-REFERENCE TO RELATED APPLICATIONS

The present application is a continuation of pending International patent application PCT/EP2005/012656 filed on Nov. 26, 2005 which designates the United States and claims priority from German patent application 10 2004 061 171.8 filed on Dec. 16, 2004, the content of which is incorporated herein by reference.

### FIELD OF THE INVENTION

The present invention relates to a method for activating and/or intensifying a capacity exchange between at least two parties, including transactions concerning the acquisition of products and/or the use of services. In addition the invention relates to a mobile terminal for use in telecommunication networks, which is configured to execute the inventive method.

### BACKGROUND OF THE INVENTION

The prior art includes numerous methods for at least partly automated coordination and/or development of a capacity exchange between at least two parties, including transactions to acquire products and/or to make use of services, for instance a so-called electronic trade of goods and/or services over communication networks such as the Internet that facilitates methods such as those used by so-called online or Internet shops or the like.

In addition, such methods are known in the area of mobile radio technology, where for instance ring tones, background images (wallpapers), or games are acquired as products with a mobile radio telephone by way of a mobile radio network through a so-called download or the like. Orders in such cases are placed, for instance, by transmission of a so-called SMS and delivery is accomplished, for instance, through an additional corresponding transmission over the mobile radio network to the mobile radio telephone.

The disadvantage of the methods known to date in the field of electronic trading of goods and/or services is that a user requires further information on a product that is to be acquired or a service that is to be used, especially the place of acquisition, availability, price, and the like, and must himself, as a rule, obtain such information even at considerable cost. Consultation with salespersons or other personnel in the conventional sense, that is, in particular as available in non-electronic acquisition of products or use of services, is not possible as a rule.

Needs arising among individuals especially in the case of awareness of goods, products, or services that are in the possession of, or being used by, other persons—so-called spontaneous purchase impulses—concerning a purchase or use that can be called a spontaneous purchase, are not fulfilled or are only partly fulfilled, and this is especially so because further information on goods or products seen in possession of other persons, such as price, source of acquisition, or the like, is usually unknown to persons wishing to fulfill such needs. These needs, which are not immediately satisfied by the purchase of such products, are often forgotten, so that the product later is not acquired or, for lack of information on it, can no longer be acquired.

In light of these circumstances, it is the aim of the present invention to produce a method and a mobile terminal of the aforementioned type, which avoid the described disadvantages, offer improvement concerning fulfillment of needs for a spontaneous acquisition or purchase of goods or products and/or a spontaneous use of services, and in particular, allow for an easier and more complete exchange of capacities.

### SUMMARY OF THE INVENTION

For the technical fulfillment of this aim, the present invention proposes a method for activating and/or intensifying transactions that include a capacity exchange between at least two parties with respect to the acquisition of products and/or the use of services, so that, with a mobile terminal that can be operated in a telecommunication network, preferably a mobile radio network, optical and/or acoustical information is captured on at least one product of potential interest to the user of the mobile terminal and/or on at least one service of interest to the user of the mobile terminal; the captured information is transmitted by an information service of the telecommunication network to a data processing system that can be connected with the telecommunication network; further information on the product of potential interest to the user of the mobile terminal and/or on the service of potential interest to the user of the mobile terminal is determined by the data processing system on the basis of the captured information; the determined further information is transmitted at least partly to the user's mobile terminal by an information service of the telecommunication network and is retrieved by the mobile terminal.

The invention is based on the awareness that it is possible to satisfy needs for a spontaneous acquisition or purchase of goods or products and/or for a spontaneous use of services through the use, according to the invention, of a mobile terminal that can be operated in a telecommunication network and is capable of capturing optical and/or acoustical information in a simple manner, especially because products and/or services seen with other persons and which are of potential interest to the user of the mobile terminal can be captured with the mobile terminal and immediately, that is especially for the duration of this spontaneous purchase impulse, such transactions of a capacity exchange for the acquisition of such products and/or the use of such services can be activated and completed. For this purpose the user of the mobile terminal, according to the invention, receives additional information that offer an especially intensified impulse for the acquisition of products and/or the use of services immediately on his mobile terminal, so that the continuation of transactions aimed at such a capacity exchange concerning the acquisition of such products and/or the use of such services can be carried out simply and intensively.

In an advantageous embodiment of the invention the capture of the optical and/or acoustical information on the product and/or service that is of interest to the user of the mobile terminal and/or the transmission of the same to the data processing system is accomplished by selection input by the mobile terminal, preferably through acoustical and/or mechanical input by the mobile terminal. IN an especially preferred embodiment of the invention the selection input carried out in the context of the capture and/or transmission is carried out by activation of keys by the mobile terminal. Here the mobile terminal advantageously comprises an appropriate service menu with a menu guide, which allows the selection input by activation of only a few keys, and preferably just a single key. Consequently it is possible, advantageously to realize a reduction in the selection inputs that are to be carried out by the user of the mobile terminal, so that the user of the mobile terminal is not prevented from an acquisition of products and/or a use of services by uselessly required, complicated, and time-consuming selection inputs.

Additional information on the product and/or service of potential interest to the user of the mobile terminal is advantageously determined at least partly in automated form by the data processing system, preferably with at least one optical and/or acoustical comparison.

With optical and/or acoustical recognition or identification means of the data processing system that use such recognition or identification algorithms or similar programs, not on the basis of optical and/or acoustical information captured by or with the mobile terminal concerning products and/or services and relating to automated, unequivocally recognizable or identifiable products and/or services, the products and/or services can for instance be recognized or identified by persons operating the data processing system or the same operational or service personnel. In addition, the additional information on recognized or identified products and/or services is determined by the data processing system, for instance by classification from one or more databases with product and/or service information that may be available by means of the data processing system itself or can be connected with it over communication networks.

In another advantageous embodiment of the invention the information transmitted to the mobile terminal contains at least one item of information that is useful for a purchase of the product and/or for use of the service, such as for instance the name of the provider or supplier of the product or the provider of the service, the price, and similar supplementary product or service information. Advantageously, only the information that is relevant or interesting for the user for the purchase of a product and/or for the use of a service is transmitted. Here, in a particularly advantageous embodiment of the invention, the user's preferences can be taken into account, for instance by means of previous orders, and/or can be indicated by this record, for instance by means of a selection list in a menu of the mobile terminal.

Advantageously, a purchase of the product and/or a use of the service proceeds through selection input by the mobile terminal, preferably through acoustical and/or mechanical input by the mobile terminal. Here the mobile terminal advantageously comprises a corresponding service menu with a menu guide, to allows the selection input by activation of just a few keys, preferably only a single key. As a result, advantageously, an additional reduction can be accomplished in the selection inputs to be executed by the user of the mobile end, so that the user of the mobile terminal is delayed in making a purchase of products and/or a use of services by unnecessarily required, complex, and time-consuming selection inputs. The selection input here is advantageously designed in such a way that transactions of the capacity exchange, especially a binding order, cannot be cancelled inadvertently or unintentionally.

An additional advantageous embodiment of the invention foresees that the information useful for purchasing a product and/or using a service is retrieved in selectable form by the mobile terminal, preferably in the form of a selectable coupling to a data processing system that coordinates the additional capacity exchange between the parties. The coupling is advantageously made according to type of a so-called link, to the data processing system that coordinates the additional capacity exchange between the parties, and is performed by way of an information service and/or by means of a service of the telecommunication network that uses http connections or similar connections, preferably a mobile radio network or the Internet.

Advantageously, in the framework of selection input by the user of the mobile terminal, order information on the product to be acquired and/or the service to be used is transmitted to the data processing system that coordinates the capacity exchange, preferably including information on number, size, type, and the place, time, and/or recipient of delivery or of performance.

Advantageously, the product and/or service on the part of the mobile terminal consists of information that can be used, processed, and/or fulfilled, preferably acoustical and/or optical information or programs that include or use acoustical and/or optical information, most preferably for entertainment, information, and/or educational purposes. Additional advantageous embodiments of the invention are characterized by acoustically and/or optically identifiable physical goods as product and/or by ring tones, musical pieces, video clips, and/or background images as product.

In additional advantageous embodiment of the invention, the optical and/or acoustical information on the product and/or service that is of potential interest to the user of the mobile terminal is captured by the mobile terminal by means of a report by an information service of the telecommunication network. Thus, local site indications concerning the acquisition of a produce and/or the like can advantageously be provided, for instance by means of so-called cell broadcasting. The report by the information service is thus usable for the user of the mobile terminal in the manner of a promotion flyer with direct ordering option, especially by product and/or service purveyors who are in the local vicinity of the particular location of the user of the mobile terminal.

An additional advantage embodiment of the invention foresees that the optical information on the product and/or service that is of potential interest to the user of the mobile terminal is captured by the mobile terminal by way of a digital video camera that can be connected with the mobile terminal or can be integrated into the mobile terminal. In an additional advantageous embodiment of the invention, the acoustical information on the product and/or service that is of potential interest to the user of the mobile terminal is captured by the mobile terminal by means of a microphone that can be connected with the mobile terminal or that is integrated in the mobile terminal.

Information captured by the mobile terminal can advantageously be stored in a digital storage unit of the mobile terminal. The storage unit, which preferably is removable, can thus be of types such as Compact Flash, Multimedia Card (MMC), Secure Digital (SD) Card, Smart Media (SM) Card, IBM Microdrive or Sony Memory Stick.

The information service of the telecommunication network used in conjunction with the invention is advantageously a multimedia messaging service (MMS). In another embodiment of the invention the information service for acoustical information is a language service. The language service in this case is advantageously configured or adapted as Dialog/IVR or as a retrieved report.

In addition, to fulfill the aim of the invention, a mobile terminal for use in telecommunication networks is proposed which is configured to executive a method according to the invention. The mobile terminal can advantageously be operated in mobile radio networks, preferably a mobile radio telephone. The mobile terminal also advantageously comprises a digital video camera to capture optical information and/or a microphone to capture acoustical information. Advantageously the mobile terminal has Multimedia Service (MMS) capability and/or language service capability.

Further details, characteristics, and advantages of the invention are presented more closely hereafter with reference to the embodiments shown in the illustrations.

### BRIEF DESCRIPTION OF THE DRAWINGS

FIG. 1 show in a schematic manner the principal functioning of an embodiment of the inventive method.

### DETAILED DESCRIPTION OF THE INVENTION

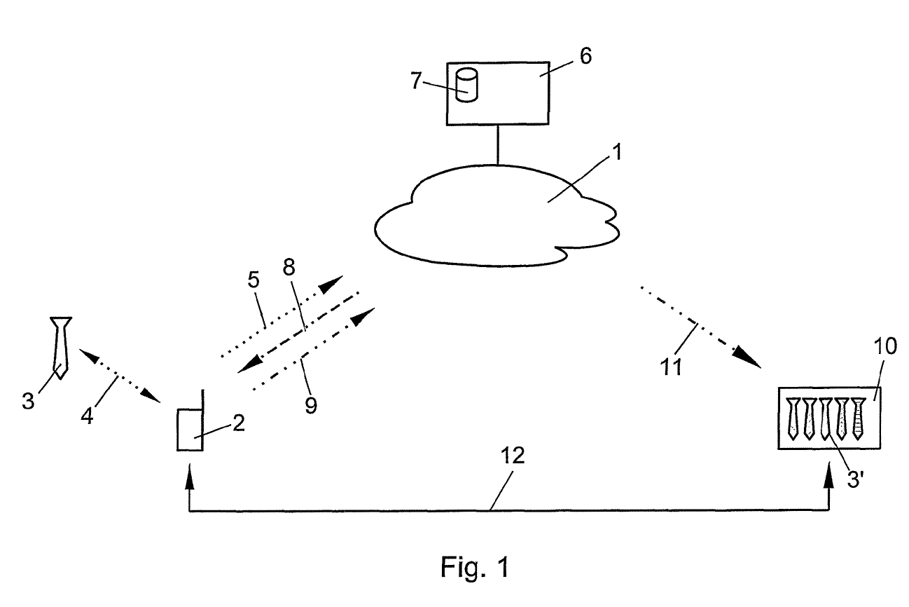

FIG. 1 shows the theoretical flow of a method to stimulate and/or intensify a capacity exchange between a user of a mobile terminal 2 that can be operated in a mobile radio network 1—primarily a mobile radio telephone with integrated digital video camera—and a product provider or supplier 10 including transactions concerning the acquisition of products 3′, primarily neckties.

Here the user of the mobile terminal 2 that can be operated in the mobile radio network 1 captures with its integrated digital video camera optical information—primarily in the form of a photograph—of a product 3 of potential interest to him, primarily a necktie, which the user of the mobile terminal 2 has seen or learned about on another person. The capture of the optical information on the product 3, that is the production of the photo of the necktie, is designated in FIG. 1 with reference number 4.

The optical information captured by the mobile terminal 2 is transmitted by the user of the mobile terminal 2 by means of an information service 5 of the mobile radio network 1, primarily a multimedia messaging service (MMS) of the mobile radio network 1, to a data processing system 6 that is connected with the mobile radio network 1 or can be connected with it. Additional information on or for the product of potential interest to the user of the mobile terminal 2 is determined or ascertained by the data processing system 6 that comprises at least one database 7, on the basis of the transmitted captured optical information by at least one optical comparison, at least by partially automated methods and is transmitted by an information service 8 of the mobile radio network 1, primarily a multimedia messaging system (MMS) of the mobile radio network 1, to the mobile terminal 2 of the user and there is retrieved by a display device of the mobile terminal. Additional information here includes primarily, besides an optical retrieval of the product 3 or 3′ of potential interest to the user of the mobile terminal, in particular information concerning the provider or supplier of the product 3′ and the price of the product 3′ as well as information useful for an acquisition of the product 3′ in the form of a selectable connection for selection and activation of the additional capacity exchange with the product provider or supplier 10.

With a selection entry by the user of the mobile terminal 2, primarily by activation of a key deliberately provided for this purpose by the mobile terminal 2, a corresponding order of the product 3′ is transmitted by an information service 9 or 11 of the mobile radio network 1 to the product provider or supplier 10. The order report transmitted with the information service by the user of the mobile terminal 2 is thus primarily complemented by the operator of the mobile radio network 1 with information on the user of the mobile terminal 2, for instance his name and/or address, and then correspondingly prepared with the information service designated in FIG. 1 with the reference number 11 for the product provider or supplier 10. The order report 9 or 11 contains primarily especially information on the number, size, type, and supplier address of the product 3′ for which a purchase is desired by the user of the mobile terminal.

Thereafter the capacity exchange designated in FIG. 1 with reference number 2 takes place between the user of the mobile terminal and the product provider or supplier 10, that is primarily the supply of the product 3′ by the product provider or supplier 10 to the user of the mobile terminal 2 and the payment of the product provider or supplier 10 for the product 3′ by the user of the mobile terminal 2.

The embodiment illustrated in the illustration serves only to explain the invention and is not restrictive with respect to the invention.

1. A method for activating and/or intensifying a capacity exchange between at least two parties, including transactions concerning the acquisition of products and/or the use of services, characterized in that optical and/or acoustical information on at least one product of potential interest to the user of the mobile terminal and/or on at least one service of potential interest to the user of the terminal is captured with a mobile terminal that can be operated in a telecommunication network, preferably a mobile radio network; the captured information is transmitted by an information service of the telecommunication network to a data processing system that can be connected with the telecommunication network; additional information on the product and/or service that is of potential interest to the user of the mobile terminal is determined by the data processing system on the basis of the captured information; the determined additional information is transmitted at least in part by an information service of the telecommunication network to the mobile terminal of the user and retrieved by the mobile terminal.

2. A process according to claim 1, characterized in that the capture of the optical and/or acoustical information of the product and/or service of potential interest to the mobile terminal and/or the transmission of the same to the data processing system is accomplished through selection input by the mobile terminal, preferably through acoustical and/or mechanical input by the mobile terminal.

3. A process according to claim 1, characterized in that the additional information on the product and/or service of potential interest to the user of the mobile terminal is determined at least partly in automated manner by the data processing system, preferably with at least one optical and/or acoustical comparison.

4. A process according to claim, characterized in that the information transmitted to the mobile terminal contains at least one item of information that is usable for an acquisition of the product and/or the use of the service.

5. A process according to claim 4, characterized in that an acquisition of the product and/or a use of the service is accomplished through selection input by the mobile terminal, preferably through acoustical and/or mechanical input by the mobile terminal.

6. A process according to claim 4, characterized in that the information that is usable for an acquisition of the product and/or a use of the service is retrieved in selectable form by the mobile terminal, preferably in the form of a selectable connection to a data processing system that coordinates the additional capacity exchange between the parties.

7. A process according to claim 5, characterized in that in the context of the selection input by the user of the mobile terminal, ordering information on the product to be acquired and/or the service to be used is transmitted to the data processing system that coordinates the capacity exchange, preferably including information on number, size, type, and place, time, and/or recipient of delivery or performance.

8. A process according to claim 1, characterized in that the product and/or the service by the mobile terminal is information that can be used, processed, and/or carried out, preferably acoustical and/or optical information or programs that include or use acoustical and/or optical information, most preferably for entertainment, informational, and/or educational purposes.

9. A method according to claim 8, characterized by ring tones, pieces of music, video clips, and/or background images as a product.

10. A method according to claim 8, characterized by physical goods that can be identified acoustically and/or optically as a product.

11. A method according to claim 1, characterized in that the optical and/or acoustical information on the product and/or service that is of potential interest to the user of the mobile terminal is captured by the mobile terminal by means of a report by an information service of the telecommunication network.

12. A method according to claim 1, characterized in that the optical information on the product and/or service that is of potential interest to the user of the mobile terminal is captured by the mobile terminal by means of a digital video camera that can be connected with the mobile terminal or is integrated in the mobile terminal.

13. A method according to claim 1, characterized in that the acoustical information on the product and/or service that is of potential interest to the user of the mobile terminal is captured by the mobile terminal by means of a microphone that can be connected with the mobile terminal or is integrated in the mobile terminal.

14. A method according to claim 1, characterized in that the information captured by the mobile terminal can be stored in a digital storage facility of the mobile terminal.

15. A method according to claim 1, characterized in that the information service is a multimedia messaging service (MMS).

16. A method according to claim 1, characterized in that the information service for acoustical information is a language service.

17. A mobile terminal for use in telecommunications network, characterized in that this terminal is configured to execute a method according to claim 1.

18. A mobile terminal according to claim 17, characterized in that this terminal can be operated in mobile radio networks, and preferably is a mobile radio telephone.

19. A mobile terminal according to claim 17, characterized in that this terminal comprises a digital video camera to capture optical information and/or a microphone to capture acoustical information.

20. A mobile terminal according to claim 17, characterized in that this terminal has Multimedia Messaging Service (MMS) capability and/or language service capability.
